(19) United States
(12) Patent Application Publication
(10) Pub. No.: US 2024/0362605 A1
(43) Pub. Date: Oct. 31, 2024

(54) UNIFIED CONTROLLER SYSTEM FOR POINT-OF-SALE DEVICES

(71) Applicant: FCS Processing, LLC, Austin, TX (US)

(72) Inventors: Jeff WAUGHTAL, Austin, TX (US); David Avery, Austin, TX (US)

(21) Appl. No.: 18/139,153

(22) Filed: Apr. 25, 2023

(51) Int. Cl. G06Q 20/20; G06F 13/38; G06F 13/42; G06K 7/00; G06K 7/08; G06K 7/10

(52) U.S. Cl. CPC G06Q 20/208; G06F 13/382; G06F 13/4282; G06K 7/0008; G06K 7/087; G06K 7/10297; G06F 2213/0042

(57) ABSTRACT

Disclosed are various aspects of a point-of-sale system, such aspects may include a computing device encased in a weather resistant shell and electronically connected to peripheral components through a controller board. The controller board may be located in a first void region of the weather resistant shell to allow protection of the electrical components from the elements. A point-of-sale system may include a power supply, wherein the power supply is in electrical connection with the controller board and in a second void region of the weather resistant shell. A point-of-sale system may include a payment device, having an EMV chip card reader, a magnetic stripe card reader, a near field communication (“NFC”) reader, wherein the payment device is in electrical communication with the controller board and in a third void region of the weather resistant shell. A point-of-sale system may also include a wireless radio module in electrical communication with the controller board and in a fourth void region of the weather resistant shell.

### CROSS-REFERENCE TO RELATED APPLICATIONS

The present application is being co-filed with U.S. application Ser. No. 18/139,102, titled Edge Network Monitoring and Adaptation Systems; U.S. application Ser. No. 18/139,185, titled Dual Network Synchronization Across Point-of-Sale Devices Located at an Event Environment; and U.S. application Ser. No. 18/139,201, titled Dual Network Implemented Method of a Customer Relationship Management and Point of Sale Merchandising System for Patron Experience, the contents of which are incorporated by reference herein in their entirety, the contents of which are incorporated by reference herein in their entirety.

### FIELD

The present application is in the field of computing devices. More particular, the present application is directed to optimal systems for interoperability of components within a point-of-sale device.

### BACKGROUND

A point-of-sale (“POS”) device, also known as a point-of-sale terminal or register, is an electronic system used in retail stores, businesses, and at remote events to process transactions. POS devices typically comprise a combination of hardware and software that allows customers to purchase goods and services by swiping their credit or debit cards, using mobile payments, touchless payments, or paying in cash.

POS devices most often consist of a monitor, a computer, a scanner, a chip-card reader, a swipe-card reader, near field communications, and in some instances a cash drawer, and a receipt printer. The software running on the POS device is responsible for managing inventory, generating sales reports, processing payments, presenting a user interface, and other essential retail functions.

POS devices are now most commonly associated with payment processing in restaurants, bars, and other service-based businesses. They have become an essential tool for businesses of all sizes, allowing them to process transactions quickly and efficiently while providing accurate record-keeping and inventory management.

There is a long sought need to incorporate multiple plug-and-play (“PnP”) devices, peripherals, and other components to a POS device, and to further allow the rapid interchange of components. This becomes increasingly important for event processing, such as festivals, music venues, large scale gatherings, races, and sporting events, wherein the weather may cause damage to many electrical components. As such, the disclosure herein provides for a unified controller board and system that allows interoperability between components and advances the design and reparability of POS devices.

### SUMMARY

In some aspects, the techniques described herein relate to a point-of-sale system for operating in event environments, including: a computing device encased in a weather resistant shell; a USB-C controller board in electrical communication through a USB-C cable to the computing device, the USB-C controller board located in a first void region of the weather resistant shell; a power supply, wherein the power supply is in electrical connection with the USB-C controller board and in a second void region of the weather resistant shell; a payment device, having an EMV chip card reader, a magnetic stripe card reader, a near field communication (“NFC”) reader, wherein the payment device is in electrical communication with the USB-C controller board and in a third void region of the weather resistant shell; and a wireless radio module in electrical communication with the USB-C controller board and in a fourth void region of the weather resistant shell.

In some aspects, the techniques described herein relate to a system, wherein the weather resistant shell is a polymeric shell.

In some aspects, the techniques described herein relate to a system, wherein the weather resistant shell is resistant to water and dust ingress to an international standard EN 60529 and IEC 60529 IP rating 55.

In some aspects, the techniques described herein relate to a system, wherein the weather resistant shell includes a top side and a bottom side, the top side and the bottom side have a channel with a rubber inner seal and are held together with fasteners that press the rubber inner seal against the top side and the bottom side.

In some aspects, the techniques described herein relate to a system, wherein the USB-C controller board, the power supply, the payment device, and the wireless radio module are electrically connected within the weather resistant shell.

In some aspects, the techniques described herein relate to a system, further including the power supply receiving electrical power from a USB-C connection.

In some aspects, the techniques described herein relate to a system, wherein the payment device is in electrical communication with the USB-C controller board through a micro-USB cable.

In some aspects, the techniques described herein relate to a system, wherein the payment device is in wireless communication with the computing device.

In some aspects, the techniques described herein relate to a system, further including an antenna in electrical communication with the wireless radio module.

In some aspects, the techniques described herein relate to a system, further including wiring gaps within an interior volume of the weather resistant shell.

In some aspects, the techniques described herein relate to a point-of-sale system for operating at events, including: a tablet computing device encased in a shell; a controller board in electrical communication to the tablet computing device, the controller board located in a first void region of the shell; a power supply, wherein the power supply is in electrical connection with the controller board and in a second void region of the shell; a payment device, having an EMV chip card reader, a magnetic stripe card reader, a near field communication (“NFC”) reader, wherein the payment device is in electrical communication with the controller board and in a third void region of shell; a wireless radio module in electrical communication with the controller board and in a fourth void region of the shell; and the tablet computing device only electrically connected to the controller board.

In some aspects, the techniques described herein relate to a system, wherein the controller board transmits both data and power to the tablet computing device.

In some aspects, the techniques described herein relate to a system, wherein the shell is a polymeric shell.

In some aspects, the techniques described herein relate to a system, wherein the shell is resistant to water and dust ingress to an international standard EN 60529 and IEC 60529 IP rating 55.

In some aspects, the techniques described herein relate to a system, wherein the shell includes a top side and a bottom side, the top side and the bottom side have a channel with a rubber inner seal and are held together with fasteners that press the rubber inner seal against the top side and the bottom side.

In some aspects, the techniques described herein relate to a system, wherein the controller board, the power supply, the payment device, and the wireless radio module are electrically connected within the shell.

In some aspects, the techniques described herein relate to a system, further including the power supply receiving electrical power from a USB-C connection.

In some aspects, the techniques described herein relate to a system, wherein the payment device in electrical communication with the controller board through a micro-USB cable.

In some aspects, the techniques described herein relate to a system, further including an antenna in electrical communication with the wireless radio module.

In some aspects, the techniques described herein relate to a system, further including wiring gaps within an interior volume of the shell, wherein the wiring gaps are voids in the shell that allow for cable management.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. Therefore, in the drawings:

FIG. 1 is a front perspective view illustration of an example point-of-sale system as disclosed herein;

FIG. 2 is a front perspective view illustration of an example point-of-sale system as disclosed herein;

FIG. 3 is a back view illustration of an example point-of-sale system as disclosed in FIG. 1;

FIG. 4 is a back view illustration of an example point-of-sale system as disclosed in FIG. 2;

FIG. 5 is a front view illustration of an example point-of-sale system as disclosed in FIG. 1;

FIG. 6 is a front view illustration of an example point-of-sale system as disclosed in FIG. 2;

FIG. 7 is a front view illustration of an example point-of-sale system of FIG. 1 with the top portion of the shell removed to display the internal configuration within the shell;

FIG. 8 is a front view illustration of an example point-of-sale system of FIG. 2 with the top portion of the shell removed to display the internal configuration within the shell;

FIG. 9 is a front view illustration of an example point-of-sale system with the top portion of the shell removed and the computing device removed to display the internal configuration within the shell;

FIG. 10 is a front view illustration of an example point-of-sale system with the top portion of the shell removed and the computing device removed to display the internal configuration within the shell;

FIG. 11 is an exploded view illustration of an example point-of-sale system controller unit;

FIG. 12 is an additional exploded view illustration of an example point-of-sale system controller unit;

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

In some aspects, the disclosure herein relates to a point-of-sale system for operating in event environments. A point-of-sale system may include a computing device such as a mobile phone, tablet computer, or other computing device that is capable of executing software, such as an operating system equipped with enough memory to store instructions for executing a customer relationship management application (“CRM”). Further, an application may include vendor store fronts, process sales transactions, and connect to a business intelligence suite. Example computing devices including processing circuitry, memory circuitry, and communications circuitry, to name a few components.

In one aspect the computing device is encased in a weather resistant shell. The weather resistant shell is designed with a rubber inner seal around entryways to provide international standard EN 60529 and IEC 60529 IP rating 55 and above. The weather resistant shell may also comprise an adhesive to help seal, or a lubricant applied to an inner rubber seal for preservation and longevity of the weather resistance. Further, the weather resistant shell may be comprised of a polymeric material, and may also be embedded with rubber on the edges or metal may be introduced within the polymeric shell for rigidity. Weather resistance also includes resistance to dust, through baffles and the rubber inner seal. Such resistance to dust also allows for heat dissipation through the baffles. Further, the weather resistant shell may be made out of colors that display higher reflection of unwanted solar radiation. The weather resistant shell benefits from being 1) Lightweight: the weather resistant shell is lightweight, which reduces the overall weight of the device. This is important for portable point-of-sale devices, such as smartphones, tablets, and laptops; 2) Durability: the weather resistant shell is highly durable and can withstand a range of environmental conditions, such as temperature changes, humidity, and exposure to water or chemicals. This helps protect the electronic components inside from damage; 3) Insulation: the weather resistant shell provides electrical insulation, which helps prevent short-circuits and other electrical problems; 4) Cost-effective: the weather resistant shell is often less expensive to manufacture than other materials, such as metal or glass. This makes the design a cost-effective option for protecting the electrical components, such as the computing device and controller board.

Continuing, a USB-C controller board may be configured to a void region within the weather resistant shell, and so configured to reduce movement and to secure the electrical components. Void regions are regions that are carved out, formed, molded, or otherwise occupy space on the interior of the weather resistant shell, and as such may also be surrounded by rubber inner seals. These void regions are areas for peripheral components, circuity, and other plug-n-play elements. The USB-C controller board serves as the main entry point for peripheral communication, and is equipped with a processing unit, memory, and circuitry that allow it to receive data and power, and to establish a single connection to the computing device that may be running a CRM application. In this aspect, the controller board is a computing device itself, and therefore is equipped with I/O capability as well as, in some instances, the ability to modulate power from a power source.

The USB-C controller is in one aspect, in electrical communication through a USB-C cable to the computing device. In other aspects it may be through another USB standard, or other communications cable. The USB-C controller board may be located in a first void region of the weather resistant shell. Therefore, the first void region may be specially designed to the form factor of the USB-C controller board, which may also be known herein as a controller board. A power supply may be defined in a second void region, and the power supply contains components for regulating power to the controller board. The power supply typically converts AC current to DC, along with regulating voltage for a stable and reliable DC source. The power supply typically comprises two components, a transformer and a rectifier. The transformer steps down the AC voltage and the rectifier converts the power to DC. The power supply may further have a DC plug input, such as a barrel connector, or may be fitted with a USB-C connector for obtaining power from a wall socket, battery, or other power source.

Continuing, a payment device, having an EMV (Europay, Mastercard, Visa) chip card reader, a magnetic stripe card reader, a near field communication (“NFC”) reader may be in electrical communication with the USB-C controller board and located in a third void region of the weather resistant shell. The void regions are in no particular order and the nomenclature is for simplicity, not design, thus the reference may define one position over another, and still maintain the spirit of the invention. EMV technology is a global standard for secure payments that uses a microprocessor chip embedded in the card to generate a unique code for each transaction, making it more difficult for fraudsters to counterfeit or skim card information. NFC is a wireless communication technology that enables two devices to communicate with each other over a short distance (typically within a few centimeters). NFC is based on radio-frequency identification (RFID) technology and operates at a frequency of 13.56 MHz NFC enables devices to exchange data and initiate actions by simply placing them in close proximity to each other. For example, NFC can be used to make contactless payments, transfer data between devices, and pair Bluetooth devices. NFC operates in two modes: active and passive. In active mode, both devices are powered and can exchange data with each other. In passive mode, one device is powered (e.g., a computing device) and the other device is unpowered (e.g., an NFC tag), and the powered device can read data from the unpowered device. NFC uses advanced security features, such as encryption and authentication, to ensure that communication between devices is secure and private.

Continuing, a wireless radio module may be in electrical communication with the USB-C controller board and in a fourth void region of the weather resistant shell. Further, the wireless radio module may also occupy a separate region, such as a fifth void area for an antenna, wherein they may be considered one void region. A wireless radio module or chipset for mobile computing devices is a set of electronic components that enables wireless communication between the mobile device and other devices or networks. The chipset typically includes a radio frequency (RF) transceiver, a baseband processor, and other support components. The RF transceiver is responsible for transmitting and receiving wireless signals, such as Wi-Fi, Bluetooth, or cellular signals. The baseband processor is responsible for encoding and decoding the digital signals that are sent and received by the RF transceiver, as well as performing other tasks, such as encryption and error correction. In addition to the RF transceiver and baseband processor, a wireless radio module may also include other components, such as power management and voltage regulation circuits, memory, and interface controllers. Overall, the wireless radio module enables mobile computing devices to connect wirelessly to other point-of-sale devices or networks, such as Wi-Fi networks, cellular networks, or Bluetooth devices/peripherals.

In some aspects, the techniques described herein relate to a point-of-sale system for operating at events. Events include music festivals, art festivals, culture festivals, music venues, outdoor events, professional sporting events. Most of these events are in remote settings or settings in which internet connection (cellular, wireless) may suffer from service availability, dropped packets, congestion, and interference to name a few. Difficulty with internet connection is often referred to as intermittent internet connection, and is most often attributed to wireless connectivity. Ethernet connections may suffer from the same issues, but are not referred to in the same manner herein.

In one aspect, the point-of-sale system includes a tablet computing device encased in a shell. The shell may be a polymeric shell that benefits from the same aspects as the weather resistant shell. Further, the shell may be combined with other features such as gaskets, seals, baffles, windows, ports, rigidity material, corner protectors, cable traces, and the life to accommodate the tablet computing device and peripherals.

Continuing, a controller board may be in electrical communication to the tablet computing device, the controller board located in a first void region of the shell. The controller board serves as the single connection point to the tablet computing device. In this aspect the controller board routes data from the peripherals, as well as serves as a power modulating source (in absence the power supply) for the tablet computing device. The controller may have a central processing unit or a microprocessor, memory, and is configured with bus connections, and other circuitry to allow the controller to route data traffic, prioritize data feeds, and deliver power to the tablet computing device.

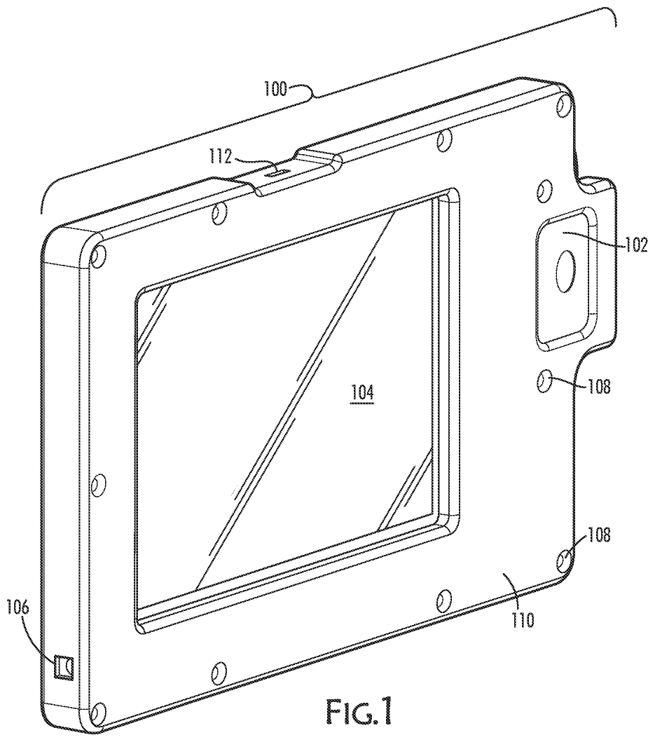

Referring now to FIG. 1, a front perspective view illustration of an example point-of-sale system 100 as disclosed herein. In one aspect, the point-of-sale system 100 is configured with a weather resistant shell 110. Wherein the weather resistant shell is rated at least IP 55 for water and dust ingress. The weather resistant shell 110 is typically comprised of two pieces, a top piece and a bottom piece, and void regions defined within the interior for accepting the computing device and peripherals. Further, the weather resistant shell 110 is held together by fasteners 108, which may compress an inner seal to provide the weather resistant aspects.

As depicted in FIG. 1, the display 104 is the display of the computing device, and it may further have additional shielding or a glare reducing layer applied. The payment device 102 is offset and encased within the weather resistant shell, and a portion is external to allow for insertion of an EMV chip card, or a swipe card transaction. An additional front portion is unshielded by the weather resistant shell to allow for NFC transactions or to allow radio frequency transmission.

In one aspect the power port 106 is a barrel port for receiving power to the power supply. In other aspects, disclosed later, the power port may be a USB-C connection that may also transfer data. Further, there may be a radio transmission window 112 of non-radio frequency interfering material, such as a thin plastic shroud, that allows for an antenna to be located beneath, or for NFC communications.

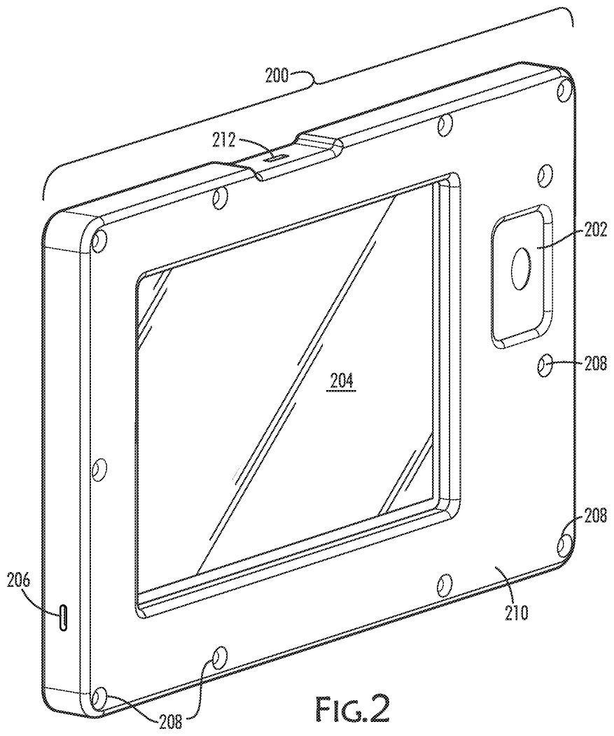

Referring to FIG. 2, a front perspective view illustration of an example point-of-sale system 200 as disclosed herein. In one aspect, the point-of-sale system 200 is configured with a weather resistant shell 210. Wherein the weather resistant shell is rated at least IP 55 for water and dust ingress. The weather resistant shell 210 is typically comprised of two pieces, a top piece and a bottom piece, and void regions defined within the interior for accepting the computing device and peripherals. Further, the weather resistant shell 210 is held together by fasteners 108, which may compress an inner seal to provide the weather resistant aspects.

As depicted in FIG. 2, the display 204 is the display of the computing device, and it may further have additional shielding or a glare reducing layer applied. The payment device 202 is encased within the weather resistant shell. An additional front portion is unshielded by the weather resistant shell to allow for NFC transactions or to allow radio frequency transmission.

In one aspect the power port 206 may be a USB-C connection that may also transfer data. Further, there may be a radio transmission window 212 of non-radio frequency interfering material, such as a thin plastic shroud, that allows for an antenna to be located beneath, or for NFC communications.

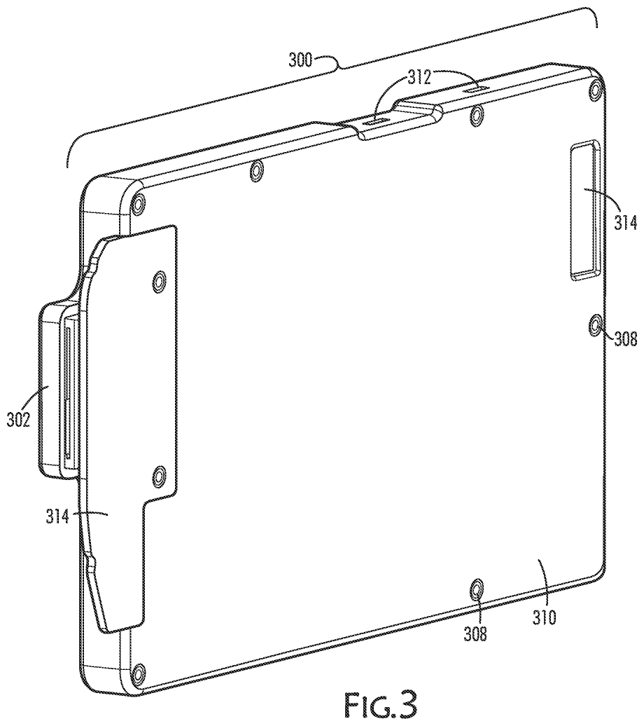

Referring to FIG. 3, a back view illustration of an example point-of-sale system 300 as disclosed in FIG. 1. In one aspect, the back side of the fasteners 308 are shown into the weather resistant shell 310. There is also an optional ID tag 314 for housing physical information about the point-of-sale system. In this aspect, the swipe card guard 314 is displayed for protecting swipe cards and channeling the card for the reader. In additional aspects, the Chip Card reader 302 is disclosed showing the insertion location for a chip card within the payment device. Lastly, the radio transmission window can be seen, allowing for NFC and radio transmissions.

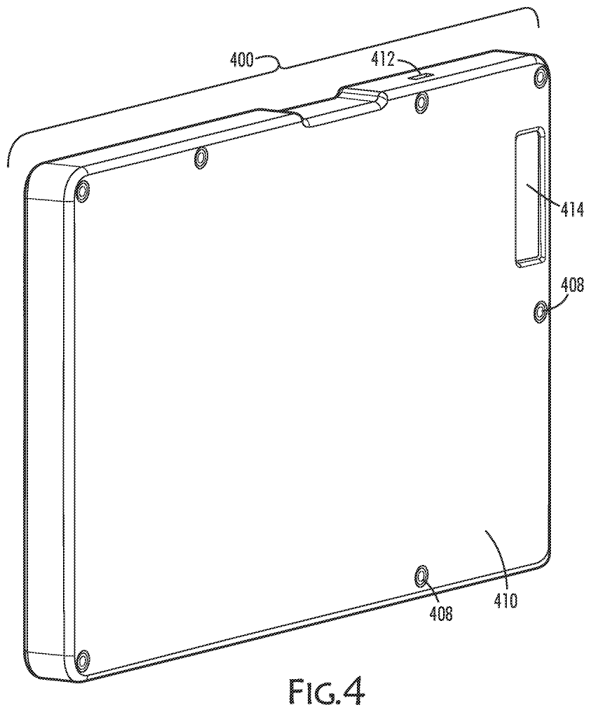

Referring to FIG. 4, a back view illustration of an example point-of-sale system 400 as disclosed in FIG. 2. In this aspect, the point-of-sale system is disclosed with the fasteners 408 on the back of the weather resistant shell 410. The ID Tag 414 is displayed with serial numbers or identifying information. There is further a radio transmission window 412 to allow radio frequency transmission and NFC communications. The corners may be braced with rubber or metal to allow further drop protection, shock protection, and insulating properties.

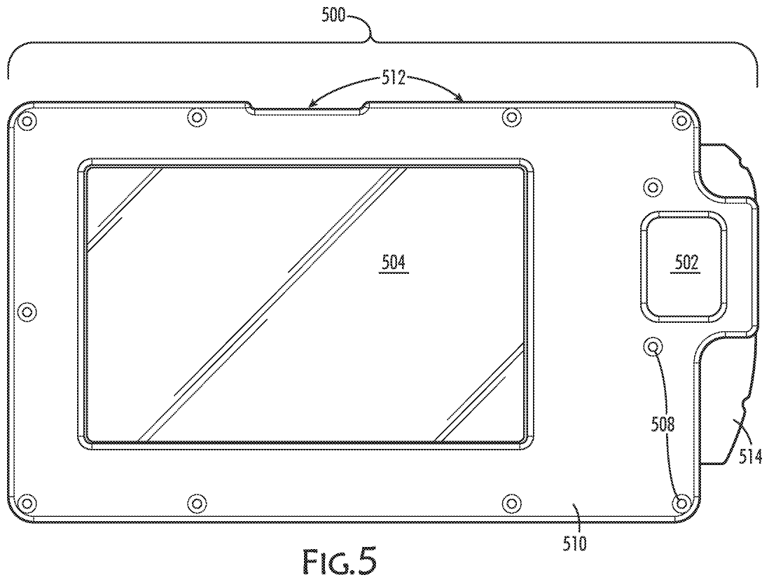

Referring to FIG. 5, a front view illustration of an example point-of-sale system 500 as disclosed in FIG. 1. In one aspect, the point-of-sale system 500 is configured with a weather resistant shell 510. Wherein the weather resistant shell is rated at least IP 55 for water and dust ingress. The weather resistant shell 510 is typically comprised of two pieces, a top piece and a bottom piece, windows, and void regions defined within the interior for accepting the computing device and peripherals. Further, the weather resistant shell 510 is held together by fasteners 108, which may compress screws, bolts, or other elements to compress an inner seal to provide the weather resistant aspects.

As depicted in FIG. 5, the display 504 is the display of the computing device, and it may further have additional shielding or a glare reducing layer applied. The payment device 502 is offset and encased within the weather resistant shell, and a portion is external to allow for insertion of an EMV chip card, or a swipe card transaction. An additional front portion is unshielded by the weather resistant shell to allow for NFC transactions or to allow radio frequency transmission. In one aspect there may be a radio transmission window 512 of non-radio frequency interfering material, such as a thin plastic shroud, that allows for an antenna to be located beneath, or for NFC communications.

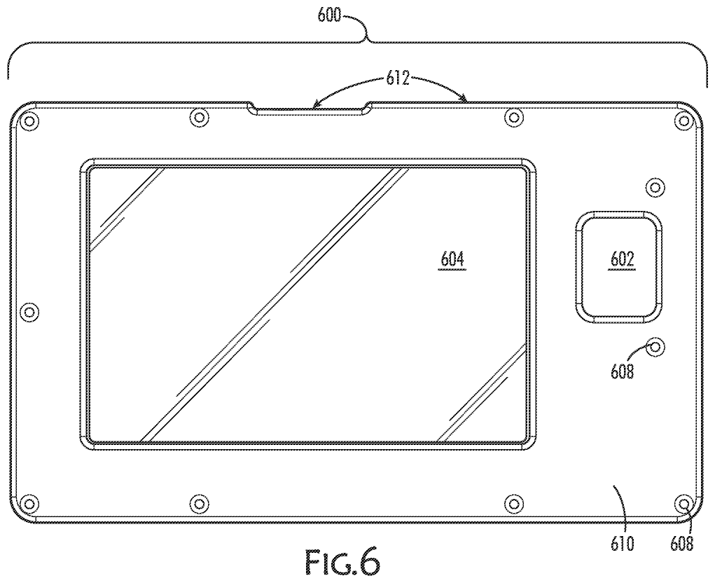

FIG. 6 is a front view illustration of an example point-of-sale system 600 as disclosed in FIG. 2. In one aspect, the point-of-sale system 600 is configured with a weather resistant shell 610. Wherein the weather resistant shell is rated at least IP 55 for water and dust ingress. The weather resistant shell 610 is typically comprised of two pieces, a top piece and a bottom piece, and void regions defined within the interior for accepting the computing device and peripherals. Further, the weather resistant shell 610 is held together by fasteners 608, which may compress an inner seal to provide the weather resistant aspects.

As depicted in FIG. 6, the display 604 is the display of the computing device, and it may further have additional shielding or a glare reducing layer applied. The payment device 602 is encased within the weather resistant shell. An additional front portion is unshielded by the weather resistant shell to allow for NFC transactions or to allow radio frequency transmission.

In one aspect there may be a radio transmission window 612 of non-radio frequency interfering material, such as a thin plastic shroud, that allows for an antenna to be located beneath, or for NFC communications.

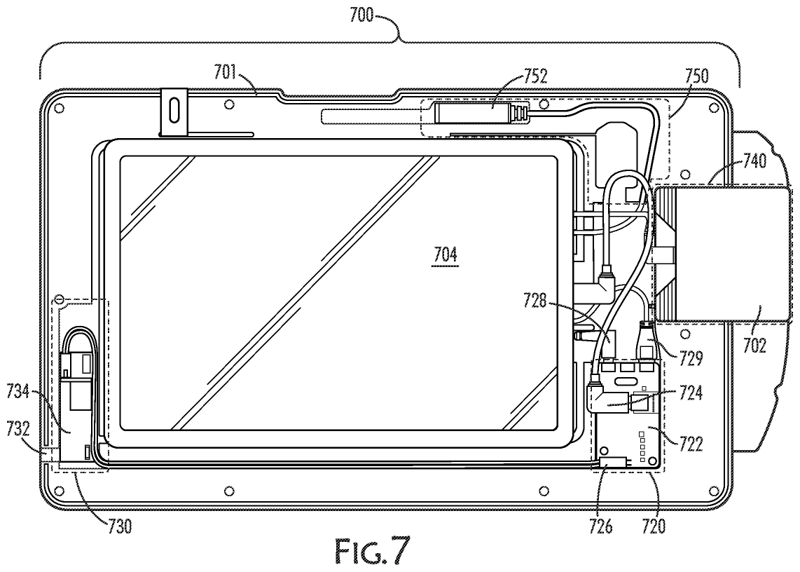

FIG. 7 is a front view illustration of an example point-of-sale system 700 in FIG. 1, with the top portion of the shell removed to display the internal configuration within the shell. In one aspect, the point-of-sale system 700 provides protection against the elements, while incorporating peripherals and circuitry in a compact all-in-one design. The weather resistant shell bottom layer is shown with a plurality of void regions. Further, an inner seal or rubber seal 701 is depicted to provide enhanced weather resistance from the elements discovered at an outdoor festival, such as humidity, aqueous solutions, dampness, moisture, as well as spills.

In this aspect, the mobile computing device 704 is disclosed inside a void region, wherein the computing device is only connected to the USB-C controller 722. The optimization allows for interconnectivity of peripherals without requiring additional ports, connectors, or I/O interfaces to the computing device. As disclosed previously, void regions may be molded, routed, sculpted, or otherwise fabricated into the shell, and can be cast the same or extruded as well. The void regions are specific to accommodate the peripheral hardware and the controller module.

The first void region 720 houses the USB-C Controller, which is in charge of unifying the peripheral devices and power, and transmitting all the resources through one USB-C cable 724 to the computing device 704. In other aspects it may be another connector such as a lightning connector, or another USB-C connector. In one aspect, the common controller board allows for an intersection for peripherals as well as up to three additional data lanes for incoming signals and power delivery. Further, the location, interior to the weather resistant shell, allows for protection of exposed circuitry.

The second void region 730 houses the power supply chipset 732 for converting 12 to 20 volts DC to 5 volts, 9 volts, 15 volts and 20 volts as required for devices using USB C power protocol, or 5 volts only for legacy devices. In addition, the voltages are sometimes filtered for spikes and then regulated. In the example of FIG. 7, the power plug 734 is a barrel connector that may take DC power and modulate for transmission into the USB-C controller 722. In this aspect, wherein the power is already in DC form, the power supply 732 does not convert the power, but regulates voltage or current. There are traces all along the interior of the shell, these traces allow for wiring routes to be held snuggly in place and to prevent any accidental disconnects.

Continuing, the third void region 740 houses the payment device 702, which may be comprised of a chip card reader, a swipe card reader, NFC reader, and Bluetooth or other wireless support for reading a payment vehicle (credit card, RFID). The payment device 702 may have a window or recess in the top portion of the shell that allows better access to NFC payments, such as that from an RFID wristband, or NFC enabled credit card. The payment device 702 is connected electrically through a cable to the USB-C controller 722, wherein the data may then be routed to the computing device 704. In this aspect, the USB-C controller routes encrypted payment data, as well as unencrypted data or payloads. Further, in some aspects, the payment data may not be encrypted by transferred to the computing device 704, where it is then encrypted prior to transmitting for verification of credit.

The fourth void region 750 houses a wireless module that may be associated with forming a peer-to-peer network between the point-of-sale systems for inter-device communication and settling. In the present figure, the wireless module is not depicted, in this aspect a USB connector to an antenna 752 is provided to receive signals for a wireless chipset on the USB-C controller 722. Example wireless modules include Sierra Wireless™ modules, such as products like the EM919X/EM7690, and may rely on processing chipsets such as, for example, a Qualcomm snapdragon™ modem. These chipsets may be able to broadcast in the 900 MHz frequency and thus create a peer-to-peer network across a plurality of point-of-sale systems. In terms of bandwidth, the 900 MHz frequency band typically provides low bandwidth transmissions, meaning that it has a limited capacity to transmit data or information, which may be ideal for payment transaction as disclosed herein. This is because the bandwidth available in this frequency range is relatively narrow compared to higher frequency bands like 2.4 GHz or 5 GHz, which can provide higher data transfer rates. There are several advantages to using the 900 MHz frequency band for low bandwidth transmissions. One advantage is that the lower frequency allows for better penetration of walls and other obstacles, making it a good choice for applications like wireless sensors and other low-power devices that need to operate reliably in challenging environments. Another advantage is that the longer wavelength of the 900 MHz frequency band allows for greater range and better signal propagation than higher frequency bands, making it a good choice for applications that require long-range wireless connectivity, such as remote monitoring or control systems. While the 900 MHz frequency band may not be ideal for high-speed data transfer applications, it is a useful and reliable option for low bandwidth transmissions in a variety of wireless applications such as with point-of-sale devices and approving or processing financial transactions.

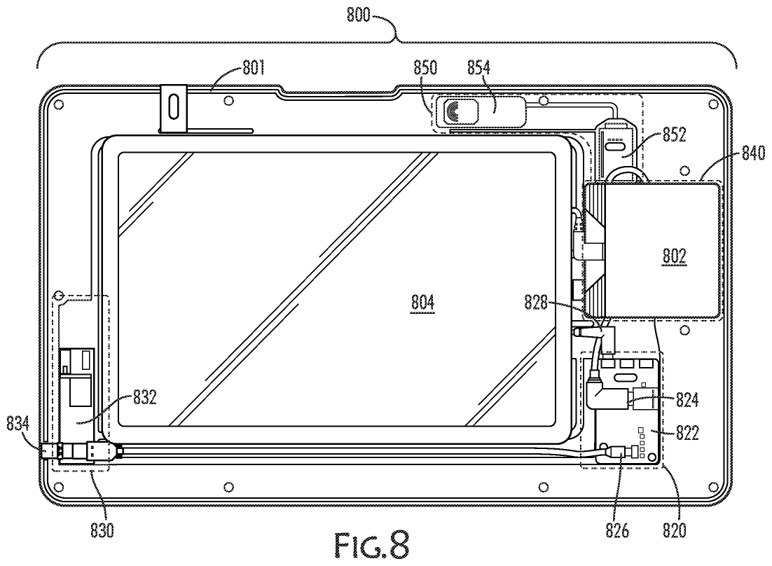

FIG. 8 is a front view illustration of an example point-of-sale system 800 with the top portion of the shell removed to display the internal configuration within the shell. In one aspect, the point-of-sale system 800 provides protection against the elements, while incorporating peripherals and circuitry in a compact all-in-one design. The weather resistant shell bottom layer is shown with a plurality of void regions. Further, an inner seal or rubber seal 801 is depicted to provide enhanced weather resistance from the elements discovered at an outdoor festival, such as humidity, aqueous solutions, dampness, moisture, dirt, and dust.

In this aspect, the mobile computing device 804 is disclosed inside a void region, wherein the computing device is only connected to the USB-C controller 822. The optimization allows for interconnectivity of peripherals without requiring additional ports, connectors, or I/O interfaces to the computing device. As disclosed previously, void regions may be molded, routed, sculpted, or otherwise fabricated into the shell, and can be cast the same or extruded as well. The void regions are specific to accommodate the peripheral hardware and the controller module.

The first void region 820 houses the USB-C Controller, which is in charge of unifying the peripheral devices and power, and transmitting all the resources through one USB-C cable 824 to the computing device 804. In other aspects it may be another connector such as a lightning connector, or another USB-C connector (USB-A, USB-B, Micro USB, or other USB standard), or other proprietary standard that allows for both power and data transfer, such as a twisted pair. In one aspect, the common controller board allows for an intersection for peripherals as well as up to three additional data lanes for incoming signals and power delivery. Further, the location, interior to the weather resistant shell, allows for protection of exposed circuitry. The additional data lanes may be accessed for additional peripherals, such as additional networking, storage, battery, or other systems such as sensor systems ancillary to the computing device.

The second void region 830 houses the power supply chipset 832 for converting 12 to 20 volts DC to 5 volts, 9 volts, 15 volts and 20 volts as required for devices using USB C power protocol, or 5 volts only for legacy devices. In the example of FIG. 7, the power plug 834 is a USB-C connector that may take power and data, and modulate voltage and current for transmission into the controller board 822. In this aspect, wherein the power is already in DC form, the power supply 832 does not convert the power, but regulates voltage or current, and may also supply data signals and serve as a data port. Further, there are traces all along the interior of the shell, these traces allow for wiring routes to be held snuggly in place and to prevent any accidental disconnects.

Continuing, the third void region 840 houses the payment device 802, which may be comprised of a chip card reader, a swipe card reader, NFC reader, and Bluetooth or other wireless support for reading a payment vehicle (credit card, RFID). In this aspect, the payment device is enclosed within the shell, and may have a window or recess in the top portion of the shell that allows better access to NFC payments, such as that from an RFID wristband, or NFC enabled credit card. This window may be sealed by a rubber inner seal to maintain water and dust resistance. The payment device 802 is connected electrically through a cable to the controller board 822, within the first void region, wherein the data may then be routed to the computing device 704. In this aspect, the controller board 822 routes encrypted payment data, as well as unencrypted data or payloads. Further, in some aspects, the payment data may not be encrypted by transferred to the computing device 804, where it is then encrypted prior to transmitting for verification of credit.

The fourth void region 850 houses a wireless module 852 that may be associated with forming a peer-to-peer network between the point-of-sale systems for inter-device communication and settling. In the present figure, the wireless module 852 is depicted with an antenna 854, in other aspects an antenna may not be needed, this depends on the range and particular hardware selected. The wireless module is in addition to any wireless chipset on the tablet computing device 804, and supports an additional network that may be utilized for means of forming a peer-to-peer system that may provide stability across the network based on leveraging out point-of-sale systems that may have a clear cellular or wireless connection to a stable resource such as an Ethernet or other highly reliable network.

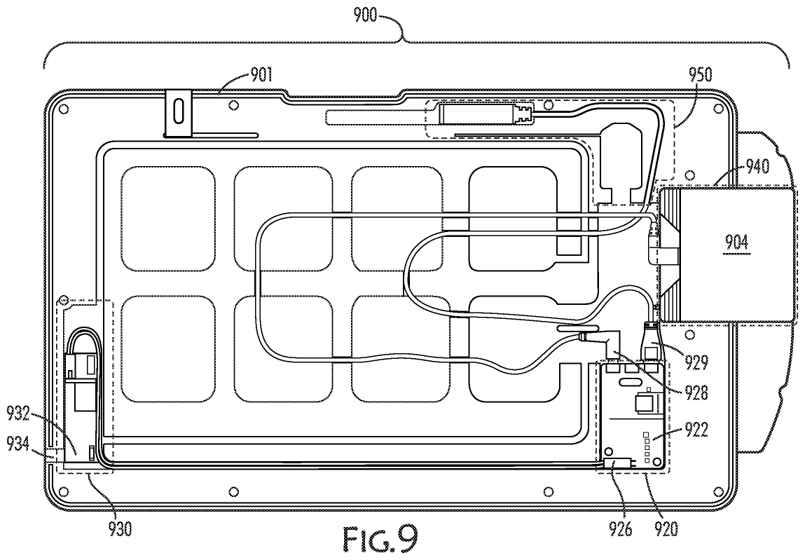

FIG. 9 is a front view illustration of an example point-of-sale system 900 with the top portion of the shell removed and the computing device removed to display the internal configuration within the shell. In one aspect, the cable tracing is depicted, showing the controller board 922 as a hub for electrical connections, wherein a single unitary connection is then configured to the computing device. In this specification, a tablet computing device, a computing device, and a mobile computing device all have the same general configurations and the terms may be used interchangeably to apply to the computing device within the point-of-sale system.

Continuing with FIG. 9, a first void region 920 may house the controller board 922, which is equipped with its own processing circuitry, and memory, and provides the ability to connect multiple peripheral devices. In one aspect, the controller board 922 is a PCB board that provides four data and power channels and one power channel. In alternative embodiments, the power channel may be power and data via a USB-C connection. Thus, the controller board 922 aggregates the data from peripherals and is electrically connected, typically through a cable, via a data and power channel to the tablet computing device (not shown in FIG. 9). The data controller 922 is located in a first void region 920, which is a depression that fits the dimensions of the data controller. The void region may be further insulated for shock, sealed with gaskets, lined with a rubber or other water repellent seal 901, and the data controller itself may be glued in place with adhesives. One aspect allows for rapid interchange of components, as daily usage in challenging environments reduces component lifetime, thus any adhesives or sealant is optimized for removal.

Continuing, the power chipset or power module 932 is located at a second void region 930, in this embodiment on the lower left corner, wherein the second void region 930 is configured to the dimensionality of the power module. The second void region 930 houses the power supply chipset 932 for converting 12 to 20 volts DC to 5 volts, 9 volts, 15 volts and 20 volts as required for devices using USB C power protocol, or 5 volts only for legacy devices. In an additional aspect, the void regions indicated by the open squares beneath the tablet computing device may house additional batteries, in this aspect, several voltage specific batteries may be wired in series or parallel to add additional power reserve so the device may operate for long durations, such as the case for week long festivals, without the need to charge. In the disclosed aspect, a USB-C port 934 is available to transmit power only, in other embodiments it may be configured to transfer both power and data.

A third void region 940, is located along the right side for the payment device 904, which in some aspects may be a bbpos™ device, such as a Chipper product https://www.bbpos.com/chipper-3x-bt/. Additional payment device peripherals may be configured based on format and options, and the ability to configure with the controller board 922. In some aspects, this includes payment devices that are equipped with Bluetooth, EMV chip card reader, dual track magnetic stripe card reader, NFC card reader, EV contactless, ISO 14443A/B, and offer USB connectivity for power and data. In the present aspect, the swipe card is disclosed with a protective guard, along with an antennae cable ran for additional NFC communication. The antenna or receiver peripheral providing a centralized location near the top of the point-of-sale device 900 for users to engage with the NFC reader. This may occur through a wristband hovering over the region, a chip card with NFC enabled, or through any other means available that may communicate across the NFC specifications. A fourth void region 950, may enclose a wireless chipset or other additional peripheral, in this aspect it is a connector to an NFC antenna or receiver. Various cable traces or gaps within the shell allow for efficient cable management, wherein the cables provide support against other peripherals.

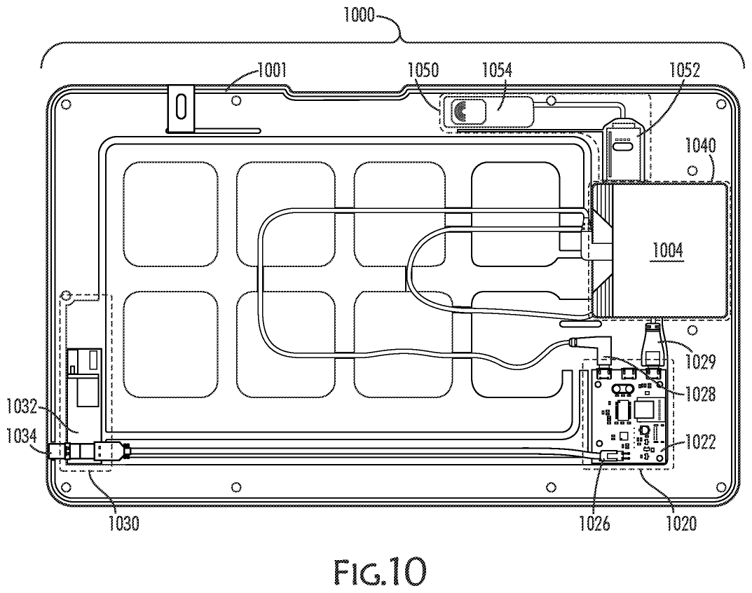

Referring now to FIG. 10, a front view illustration of an example point-of-sale system 1000 with the top portion of the shell removed and the computing device removed to display the internal configuration within the shell. a first void region 1020 may house the controller board 1022, which is equipped with its own processing circuitry, and memory, and provides the ability to connect multiple peripheral devices. In one aspect, the controller board 1022 is a PCB board that provides four data and power channels and one power channel. In alternative embodiments, the power channel may be power and data via a USB-C connection. Thus, the controller board 1022 aggregates the data from peripherals and is electrically connected, typically through a cable, via a data and power channel to the tablet computing device (not shown in FIG. 10). The data controller 1022 is located in a first void region 1020, which is a depression that fits the dimensions of the data controller. The void region may be further insulated for shock, sealed with gaskets, lined with a rubber or other water repellent seal 1001, and the data controller itself may be glued in place with adhesives. One aspect allows for rapid interchange of components, as daily usage in challenging environments reduces component lifetime, thus any adhesives or sealant is optimized for removal.

Continuing, the power chipset or power module 1032 is located at a second void region 1030, in this embodiment on the lower left corner, wherein the second void region 1030 is configured to the dimensionality of the power module. The power module helps to regulate voltage and current, in alternative aspects the power module may also work as a transformer for AC to DC conversion. In an additional aspect, the void regions indicated by the open squares beneath the tablet computing device may house additional batteries, in this aspect, several voltage specific batteries may be wired in series or parallel to add additional power reserve so the device may operate for long durations, such as the case for week long festivals, without the need to charge. In the disclosed aspect, a USB-C port 1034 is available to transmit power only, in other embodiments it may be configured to transfer both power and data.

A third void region 1040, is located along the right side for the payment device 1004, which in some aspects may be a bbpos™ device, such as a Chipper product https://www.bbpos.com/chipper-3x-bt/. Additional payment device peripherals may be configured based on format and options, and the ability to configure with the controller board 1022. In some aspects, this includes payment devices that are equipped with Bluetooth, EMV chip card reader, dual track magnetic stripe card reader, NFC card reader, EV contactless, ISO 14443A/B, and offer USB connectivity for power and data. In the present aspect, the swipe card is disclosed with a protective guard, along with an antennae cable ran for additional NFC communication. The antenna or receiver peripheral providing a centralized location near the top of the point-of-sale device 1000 for users to engage with the NFC reader. This may occur through a wristband hovering over the region, a chip card with NFC enabled, or through any other means available that may communicate across the NFC specifications. A fourth void region 1050, may enclose a wireless chipset or other additional peripheral, in this aspect it is a connector to an NFC antenna or receiver. Various cable traces or gaps within the shell allow for efficient cable management, wherein the cables provide support against other peripherals.

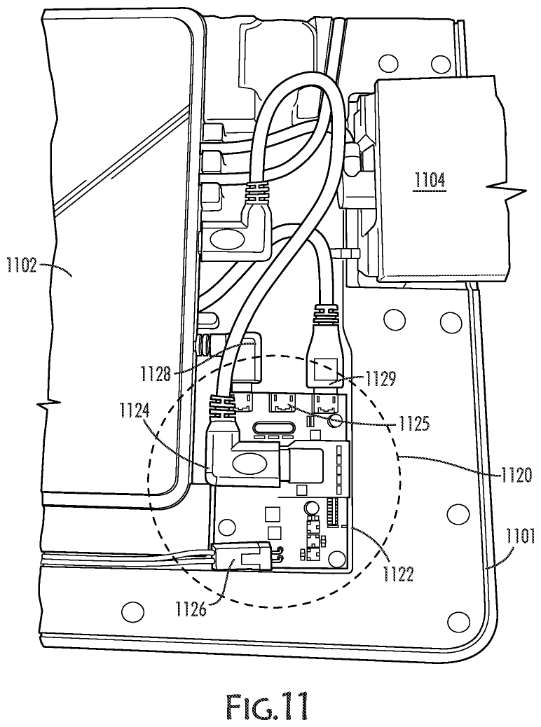

FIG. 11 is an exploded view illustration 1120 of an example point-of-sale system controller board 1122. In this aspect the payment device 1104 is configured to electrically connect to the controller board 1122, to receive a payment vehicle, such as a credit card or wrist band input, the controller board 1122, then routes the data stream to the tablet computing device 1102, wherein it enters memory and is executed on a processor within the tablet computing device. The singular connection to the tablet computing device 1102 is the USB-C connection 1124 from the controller board 1122, wherein it transmits data and power to the tablet computing device 1102. The power cable 1126 enters the controller board from a second void region (not depicted) and supplies power to the controller board 1122, which in turn routes power to the peripheral components (payment device, wireless chipset), as well as the tablet computing device 1102. Additional data and power lanes 1128, 1129 connect to peripheral components and form the I/O channels within the controller board 1122.

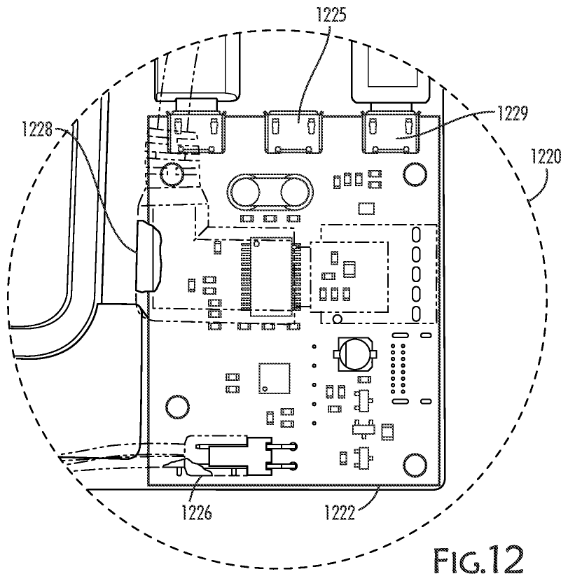

Referring now to FIG. 12, an additional exploded view illustration of an example point-of-sale system 1220 controller unit or controller board 1222. In this exploded aspect the controller board is shown with an example wiring diagram. In particular, the power connector 1226 may be configured as an additional data/power lane. Further, the additional USB connection 1225 may be enabled to allow additional peripherals, such as additional storage systems, networking, or more. In dotted line, the single connector 1228 to the tablet computing device is configured to allow multi data lane entry and power delivery, so as to streamline the peripherals and provide an optimal configuration so that the point-of-sale device remains light weight, balanced, and capable of integrating multiple peripherals. The available data and power lines may be used for interconnecting and for power delivery, for example, one data and power lane 1229 may be provided for the payment device, whereas another may provide access to a network chipset for forming a local swarm network or optimized software defined network between point-of-sale devices, each acting as a beacon or node.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

It should be emphasized that the above-described embodiments of the present disclosure are merely possible examples of implementations set forth for a clear understanding of the principles of the disclosure. Many variations and modifications may be made to the above-described embodiments without departing substantially from the scope and principles of the disclosure. All such modifications and variations are intended to be included herein within the scope of this disclosure and protected by the following claims.

The disclosure herein may be further viewed as the following Implementations:

Clause 1. A point-of-sale system for operating in event environments, comprising: a computing device encased in a weather resistant shell; a USB-C controller board in electrical communication through a USB-C cable to the computing device, the USB-C controller board located in a first void region of the weather resistant shell; a power supply, wherein the power supply is in electrical connection with the USB-C controller board and in a second void region of the weather resistant shell; a payment device, having an EMV chip card reader, a magnetic stripe card reader, a near field communication (“NFC”) reader, wherein the payment device is in electrical communication with the USB-C controller board and in a third void region of the weather resistant shell; and a wireless radio module in electrical communication with the USB-C controller board and in a fourth void region of the weather resistant shell.

Clause 2. The system of clause 1, wherein the weather resistant shell is a polymeric shell.

Clause 3. The system of clause 1, wherein the weather resistant shell is resistant to water and dust ingress to an international standard EN 60529 and IEC 60529 IP rating 55.

Clause 4. The system of clause 1, wherein the weather resistant shell comprises a top side and a bottom side, the top side and the bottom side have a channel with a rubber inner seal and are held together with fasteners that press the rubber inner seal against the top side and the bottom side.

Clause 5. The system of clause 1, wherein the USB-C controller board, the power supply, the payment device, and the wireless radio module are electrically connected within the weather resistant shell.

Clause 6. The system of clause 1, further comprising the power supply receiving electrical power from a USB-C connection.

Clause 7. The system of clause 1, wherein the payment device is in electrical communication with the USB-C controller board through a micro-USB cable.

Clause 8. The system of clause 1, wherein the payment device is in wireless communication with the computing device.

Clause 9. The system of clause 1, further comprising an antenna in electrical communication with the wireless radio module.

Clause 10. The system of clause 1, further comprising wiring gaps within an interior volume of the weather resistant shell.

Clause 11. A point-of-sale system for operating at events, comprising: a tablet computing device encased in a shell; a controller board in electrical communication to the tablet computing device, the controller board located in a first void region of the shell; a power supply, wherein the power supply is in electrical connection with the controller board and in a second void region of the shell; a payment device, having an EMV chip card reader, a magnetic stripe card reader, a near field communication (“NFC”) reader, wherein the payment device is in electrical communication with the controller board and in a third void region of shell; a wireless radio module in electrical communication with the controller board and in a fourth void region of the shell; and the tablet computing device only electrically connected to the controller board.

Clause 12. The system of clause 11, wherein the controller board transmits both data and power to the tablet computing device.

Clause 13. The system of clause 11, wherein the shell is a polymeric shell.

Clause 14. The system of clause 11, wherein the shell is resistant to water and dust ingress to an international standard EN 60529 and IEC 60529 IP rating 55.

Clause 15. The system of clause 11, wherein the shell comprises a top side and a bottom side, the top side and the bottom side have a channel with a rubber inner seal and are held together with fasteners that press the rubber inner seal against the top side and the bottom side.

Clause 16. The system of clause 11, wherein the controller board, the power supply, the payment device, and the wireless radio module are electrically connected within the shell.

Clause 17. The system of clause 11, further comprising the power supply receiving electrical power from a USB-C connection.

Clause 18. The system of clause 11, wherein the payment device in electrical communication with the controller board through a micro-USB cable.

Clause 19. The system of clause 11, further comprising an antenna in electrical communication with the wireless radio module.

Clause 20. The system of clause 11, further comprising wiring gaps within an interior volume of the shell, wherein the wiring gaps are voids in the shell that allow for cable management.

Therefore, the following is claimed:

1. A point-of-sale system for operating in event environments, comprising:
a computing device encased in a weather resistant shell;
a USB-C controller board in electrical communication through a USB-C cable to the computing device, the USB-C controller board located in a first void region of the weather resistant shell;
a power supply, wherein the power supply is in electrical connection with the USB-C controller board and in a second void region of the weather resistant shell;
a payment device, having an EMV chip card reader, a magnetic stripe card reader, a near field communication (“NFC”) reader, wherein the payment device is in electrical communication with the USB-C controller board and in a third void region of the weather resistant shell; and
a wireless radio module in electrical communication with the USB-C controller board and in a fourth void region of the weather resistant shell.

2. The system of claim 1, wherein the weather resistant shell is a polymeric shell.

3. The system of claim 1, wherein the weather resistant shell is resistant to water and dust ingress to an international standard EN 60529 and IEC 60529 IP rating 55.

4. The system of claim 1, wherein the weather resistant shell comprises a top side and a bottom side, the top side and the bottom side have a channel with a rubber inner seal and are held together with fasteners that press the rubber inner seal against the top side and the bottom side.

5. The system of claim 1, wherein the USB-C controller board, the power supply, the payment device, and the wireless radio module are electrically connected within the weather resistant shell.

6. The system of claim 1, further comprising the power supply receiving electrical power from a USB-C connection.

7. The system of claim 1, wherein the payment device is in electrical communication with the USB-C controller board through a micro-USB cable.

8. The system of claim 1, wherein the payment device is in wireless communication with the computing device.

9. The system of claim 1, further comprising an antenna in electrical communication with the wireless radio module.

10. The system of claim 1, further comprising wiring gaps within an interior volume of the weather resistant shell.

11. A point-of-sale system for operating at events, comprising:
a tablet computing device encased in a shell;
a controller board in electrical communication to the tablet computing device, the controller board located in a first void region of the shell;
a power supply, wherein the power supply is in electrical connection with the controller board and in a second void region of the shell;
a payment device, having an EMV chip card reader, a magnetic stripe card reader, a near field communication (“NFC”) reader, wherein the payment device is in electrical communication with the controller board and in a third void region of shell;
a wireless radio module in electrical communication with the controller board and in a fourth void region of the shell; and
the tablet computing device only electrically connected to the controller board.

12. The system of claim 11, wherein the controller board transmits both data and power to the tablet computing device.

13. The system of claim 11, wherein the shell is a polymeric shell.

14. The system of claim 11, wherein the shell is resistant to water and dust ingress to an international standard EN 60529 and IEC 60529 IP rating 55.

15. The system of claim 11, wherein the shell comprises a top side and a bottom side, the top side and the bottom side have a channel with a rubber inner seal and are held together with fasteners that press the rubber inner seal against the top side and the bottom side.

16. The system of claim 11, wherein the controller board, the power supply, the payment device, and the wireless radio module are electrically connected within the shell.

17. The system of claim 11, further comprising the power supply receiving electrical power from a USB-C connection.

18. The system of claim 11, wherein the payment device in electrical communication with the controller board through a micro-USB cable.

19. The system of claim 11, further comprising an antenna in electrical communication with the wireless radio module.

20. The system of claim 11, further comprising wiring gaps within an interior volume of the shell, wherein the wiring gaps are voids in the shell that allow for cable management.
